(19) United States
(12) Patent Application Publication
(10) Pub. No.: US 2020/0281108 A1
(43) Pub. Date: Sep. 10, 2020

(54) ARRANGEMENT FOR ATTACHING A WORKING TOOL TO A WORKING MACHINE

(71) Applicant: Markus SUNDBERG, Oitti (FI)

(72) Inventor: Markus SUNDBERG, Oitti (FI)

(21) Appl. No.: 16/525,173

(22) Filed: Jul. 29, 2019

(30) Foreign Application Priority Data
Mar. 4, 2019 (FI) U20194034
Apr. 3, 2019 (FI) U20194053

(51) Int. Cl. A01B 59/06; A01B 59/043; A01B 59/00

(52) U.S. Cl. CPC A01B 59/061; A01B 59/066; A01B 59/002; A01B 59/043

(57) ABSTRACT

The invention relates to an arrangement for attaching a working tool to a working machine, preferably to a three-point hitch of the working machine, comprising a pushing arm articulated, at one end, to the working machine, and two pulling arms articulated, at one end, to the working machine. The arrangement comprises a coupling mechanism for attaching the three-point hitch, from the cabin of the working machine, to the working tool, or, to a quick hitch positioned between the working tool and the working machine.

### FIELD OF THE INVENTION

The invention relates to an arrangement for attaching a working tool to a working machine as defined in the preamble of claim 1.

Preferably, the solution according to the invention also comprises a quick hitch suitable for use as a universal quick hitch between a three-point hitch of a working machine, such as a tractor, and an implement, hereafter referred to as a working tool, to be attached to the tractor. Thus, the quick hitch preferably acts as an adapter. The arrangement of the invention also makes it easier to attach the quick hitch to the three-point hitch of the working machine. Similarly, it also makes it easier to directly attach a working tool to the three-point hitch of the working machine when no quick hitch is needed between the working tool and the working machine. The solution according to the invention is useful in agriculture and any other operation where a working tool attached to a working machine needs to be changed repeatedly.

The universal quick hitch for a working machine used in the arrangement according to the invention makes it easier and faster to attach a working tool to the working machine. When the working machine is a tractor, the working tool is often attached to a rear linkage of the tractor, often called a tractor three-point hitch.

The tractor three-point hitch is a widely used type of linkage between a tractor and a working tool. An ordinary tractor three-point hitch comprises two lower pulling arms, one upper pushing arm as well as one or more lift cylinders which usually are hydraulically driven. The lower pulling arms may also be called draw links or lift arms, and the upper pushing arm may also be called a top link.

The position of the coupling elements of the working tools to be attached to the tractor may vary between different working tools. The attaching points of the coupling elements of the working tools often are provided at different heights and widths from each other. The tractor three-point hitch must be adjustable in different ways and easy-to-use to allow a variety of working tools to be attached thereto. The widths and other dimensions of the coupling elements of the implements and working tools to be attached to the three-point hitch, positioned at the rear, and sometimes at the front, of the tractor, are not always standardized, and, there are many different standard sizes as well. Therefore, when attaching a tractor three-point hitch to implements, the coupling elements often need to be adjusted to each other before they can be connected together. In prior-art solutions, the operator of the tractor usually has to get out of the tractor to be able adjust the coupling elements of the three-point hitch of the tractor to match the coupling elements of the working tools.

The connecting dimensions according to the different categories result, for example, in that a working tool of Category 2 cannot be attached to a working machine of Category 1 or Category 3. Besides, especially larger working machines often have a robust and heavy three-point hitch pushing arm, possibly making it hard and dangerous, or even impossible, to manually lift and lower it in order to connect a quick hitch or a working tool to the pushing arm. The solution according to the invention aims at eliminating the need of the operator to get out of the working machine in order to adjust the position of the coupling elements of the three-point hitch to match, both in the height direction and in the horizontal direction, with the coupling elements of the working tool or the quick hitch. According to the solution of the invention, the operator of the working machine is able to adjust the positions of the coupling elements of the three-point hitch, manually from the cabin, without leaving his seat, thereby not only making the work easier but also safer.

### Background of the Invention and Problems Related to the Prior Art

As is known, often the problem is that, so far, the dimensions of working tools intended for working machines generally have not been standardized, and, therefore, the manufacturers have each used their own dimensions for layout and positioning of the coupling elements. This has been enabled by the wide adjustability of the three-point hitch of the tractor to match various implements and working tools, but, a drawback encountered has been the need of the operator to get out of the tractor in order to adjust the position of the coupling elements of the three-point hitch to match the coupling elements of the working tool. It can be hard to get out of the working machine for the adjustment if the operator constantly needs to change the implement of his working machine. This has also shown to be a security risk because the operator, or his assistant, needs to move between the working machine and the implement to be attached thereto while the engine of the working machine is running.

Solutions for attaching a three-point hitch to a quick hitch, having a fixed structure and not allowing the distance between the fastening elements to be adjusted in the width direction, are known. A quick hitch like this only can accommodate matching implements which follow its dimensions. A more advanced design than this is known from the U.S. Pat. No. 3,312,478.

This solution allows the horizontal distance between the lower hooks of the quick hitch to be adjusted to match the attaching points of the working tool. This solutions suffers from the drawback that the adjustment is manual, the adjustment handle being located down on the quick hitch, far away from the operator, making it impossible for the operator to reach the adjustment handle from the cabin, and, consequently, the operator has to step down to the ground between the working machine and the working tool for the width adjustment. This is a difficult task, possibly involving a security risk, as mentioned above.

A more contemporary solution is known from the European patent application No. EP3138373A1. A drawback of this solution is that the structure has a fixed width, not allowing for any adjustment of the mutual horizontal distance of the lower hooks or the coupling hooks of the quick hitch. No other than implements and working tools having a matching width can be attached to this quick hitch. Besides, in this solution, the lower hooks or the couplings only can be seen to a restricted extent. This can be a major disadvantage when attaching a working machine to an implement by driving.

There are some other known solutions which also suffer from the problem that the lower hooks of the legs of the quick hitch are poorly visible for the operator. The visibility of the lower hooks is substantially important when attaching a working machine to an implement by driving. Attaching the working machine to the implement requires driving accuracy from the operator of the working machine because the alignment of the lower hooks with the coupling elements of the implement can be a matter of centimeters. The lower hooks of the three-point hitch of the working machine are coupled to the coupling elements of the implement after an appropriate approach and accurate driving lines. When approaching the implement, the driving lines of the working machine must be within the range of the coupling elements as the implements, because of their heaviness, rarely are movable by human power. The solution according to the invention avoids the visibility problem by designing the structure to incline forward so as not to hide the lower hooks in the field of view of the operator.

The current prior-art quick hitch solutions do not allow working tools having attaching points with varying widths to be attached to a three-point hitch of a working machine, such as a tractor.

### OBJECTIVE OF THE INVENTION

This invention aims at overcoming the above-mentioned drawbacks and providing a flexible, efficient, fast and unnoticeable as well as easy-to-use arrangement for connecting a working tool or a universal quick hitch between a working machine, such as a tractor, and the working tool or the universal quick hitch. The solution according to the invention also aims at making the work of the operator of the working machine, such as the operator of the tractor, easier, at increasing work safety by mechanizing the adjustment of the coupling elements of the three-point hitch and by making it easier to attach the working machine, such as the tractor, to the working tool.

### DESCRIPTION OF THE INVENTION

The quick hitch employed by the solution according to the invention can be regarded as a type of adjustable adapter, enabling various implements and working tools attachable to working machines, such as a tractor, to be attached to the tractor without getting out of the tractor. Besides, the arrangement assists the operator of the working machine in attaching the heavy pushing arm of the three-point hitch to the working tool or the quick hitch. The arrangement according to the invention is characterized in what is set forth in claim 1. The other embodiments of the invention are characterized in what is set forth in the rest of the claims.

A typical arrangement according to the invention for attaching a working tool to a working machine, preferably to a three-point hitch of the working machine, comprising a pushing arm articulated, at one end, to the working machine and two pulling arms articulated, at one end, to the working machine comprises a coupling mechanism for attaching the three-point hitch, from the cabin of the working machine, to the working tool, or, to a quick hitch positioned between the working tool and the working machine.

A typical universal quick hitch, intended for a working machine, for attaching working tools to a three-point hitch of the working machine, and employed in the arrangement according to the invention comprises a frame, two legs with a lower hook, an upper hook as well as a width adjustment mechanism for adjusting, from the cabin of the working machine, the mutual distance between the lower hooks in the width direction.

### Advantages of the Invention

The invention makes it easier to attach a working machine, such as a tractor, to various working tools and provides better circumstances for work safety, by allowing the attaching to be carried out from the cabin, without the need of the operator, or his assistant, to step into the unsafe area between the working machine, such as the tractor, and the implement or the working tool.

The quick hitch preferably included in the arrangement according to the invention is a universal, preferably mechanically operable quick hitch acting as an adapter, enabling implements and working tools, having their coupling elements positioned in different ways, to be safely attached, from the cabin of a working machine, to the three-point hitch of the working machine.

Compared to the above-mentioned known solutions, the adjustability of the width of the fastening elements of the employed quick hitch, without having to get out of the working machine, and the mechanical implementation of the adjustment, can also be seen as an advantage. Besides, the quick hitch included in the arrangement according to the invention is laterally movable, resulting in a better alignment with the coupling elements, such as fastening pins, of the working tool.

Another advantage is that the pushing arm of the three-point hitch is safe and easy to mount, from the cabin of the working machine, to the fastening element of the working tool or the quick hitch.

### LIST OF FIGURES

In the following, the invention will be explained in more detail with reference to the accompanying simplified drawings wherein

FIG. 1 is a schematic and simplified as well as oblique top view of a working machine with a three-point hitch wherein a quick hitch according to the invention can be used,

FIG. 1a is a simplified and oblique lateral view of a quick hitch according to the invention, with one leg in partial cross-section,

FIG. 2 is a simplified and oblique lateral view of the quick hitch of FIG. 1a, with one leg in partial cross-section, and attached to the three-point hitch of the working machine, which is only partially shown,

FIG. 3 is a simplified and oblique top and lateral view of the quick hitch of FIG. 1a, attached as shown in FIG. 2 and with one leg in partial cross-section, and with essential parts separated from each other,

FIG. 4 is a simplified and oblique top and lateral view of a second preferable quick hitch according to the invention, attached as shown in FIG. 2 and with one leg in partial cross-section,

FIG. 5 is a simplified and top view of a third quick hitch according to the invention, attached as shown in FIG. 2,

FIG. 6 is a simplified and lateral view of the quick hitch of FIG. 5,

FIG. 7 is an oblique bottom and lateral and simplified view of an upper hook structure and a locking device of the quick hitch of FIG. 5, also showing the main parts of the locking device as separated,

FIG. 8 is an oblique and lateral view of a length-adjustable lateral stopper of the three-point hitch, affecting the operation of the quick hitch, in a disassembled state and in an assembled state,

FIG. 9 is a schematic, simplified and lateral view of still another quick hitch according to the invention,

FIG. 10 is a schematic, simplified and lateral view of still another quick hitch according to the invention,

FIG. 11 is a schematic, simplified and lateral view of still another quick hitch according to the invention,

FIG. 12 is a schematic, simplified and lateral view of still another quick hitch according to the invention,

FIG. 13 is a simplified and top view of a preferable width adjustment solution for the quick hitch according to the invention,

FIG. 14 is a simplified and top view of another preferable width adjustment solution for the quick hitch according to the invention,

FIG. 15 is a simplified and clarified front view of a preferable width adjustment solution and positioning of the lower hooks for the quick hitch according to the invention,

FIG. 16 is a simplified and clarified front view of another preferable width adjustment solution for the quick hitch according to the invention,

FIG. 17 is an oblique simplified and clarified exploded top view of a preferable width adjustment mechanism for the quick hitch according to the invention, manually operable from the cabin of the working machine,

FIG. 18 is an oblique simplified and clarified top view of a preferable upper hook and upper latch mechanism for the quick hitch according to the invention, manually operable from the cabin of the working machine,

FIG. 19 is an oblique simplified and clarified top view of a manual version corresponding to the quick hitch shown in FIG. 4,

FIG. 20 is a lateral simplified and clarified view of a preferable lifting and lowering mechanism for the pushing arm of the three-point hitch in the arrangement according to the invention, manually operable from the cabin of the working machine,

FIG. 21 is a lateral simplified and clarified enlarged view of the lifting and lowering mechanism of the pushing arm of the three-point hitch shown in FIG. 20,

FIG. 22 is a lateral simplified, clarified and partially cross-sectioned view of an advantageous locking and opening mechanism of a pushing arm of a three-point hitch according to the invention in the situation where the locking latch of the pushing arm is in a locked position,

FIG. 23 is a lateral simplified and clarified view of the locking and opening mechanism according to FIG. 22 in an unlocked position,

FIG. 24 is a lateral simplified, clarified, enlarged and partially cross-sectioned view of the free end of the pushing arm according to FIG. 22 in a locked position,

FIG. 25 is a lateral simplified, clarified, enlarged and partially cross-sectioned view of the free end of a pulling arm of the three-point hitch according to the invention in the situation where the locking latch of the pulling arm is in a locked position,

FIG. 26 is a lateral simplified and clarified view of an advantageous locking and opening mechanism of the pulling arm of a three-point hitch in the arrangement according to the invention, manually operable from the cabin of the working machine, and

FIG. 27 is a lateral simplified, clarified and partially cross-sectioned view of another advantageous locking and opening mechanism of the pushing arm of a three-point hitch in the arrangement according to the invention, manually operable from the cabin of the working machine.

### DETAILED DESCRIPTION OF THE EXAMPLES SHOWN IN THE FIGURES

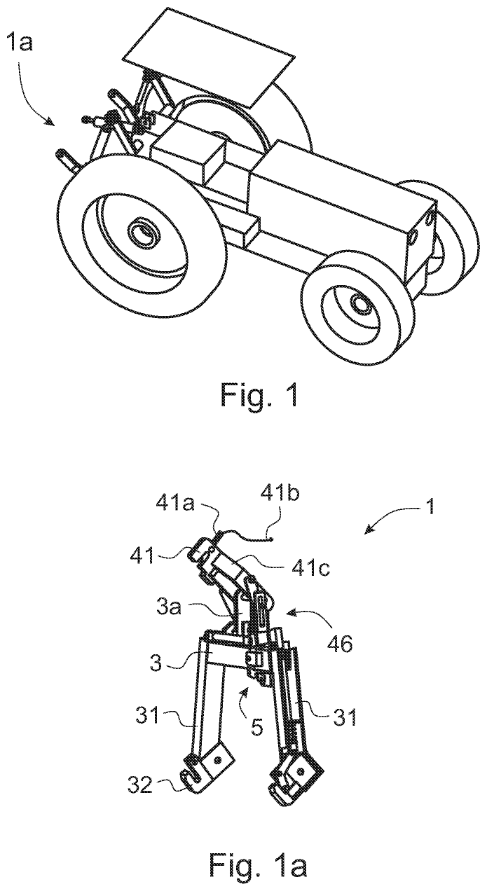

FIG. 1 is a schematic and simplified oblique top view of a working machine which is provided with a three-point hitch 1a and on which a quick hitch included in the arrangement according to the invention can be used. In this example, the working machine is a tractor and the three-point hitch 1a is situated at the rear of the tractor. Preferably, the arrangement according to the invention comprises a coupling mechanism for attaching, from the cabin of the working machine, the three-point hitch 1a to a working tool, or, to a quick hitch positioned between the working tool and the working machine. A portion of the coupling mechanism can be located in the quick hitch while another portion of it can be located in the three-point hitch 1a.

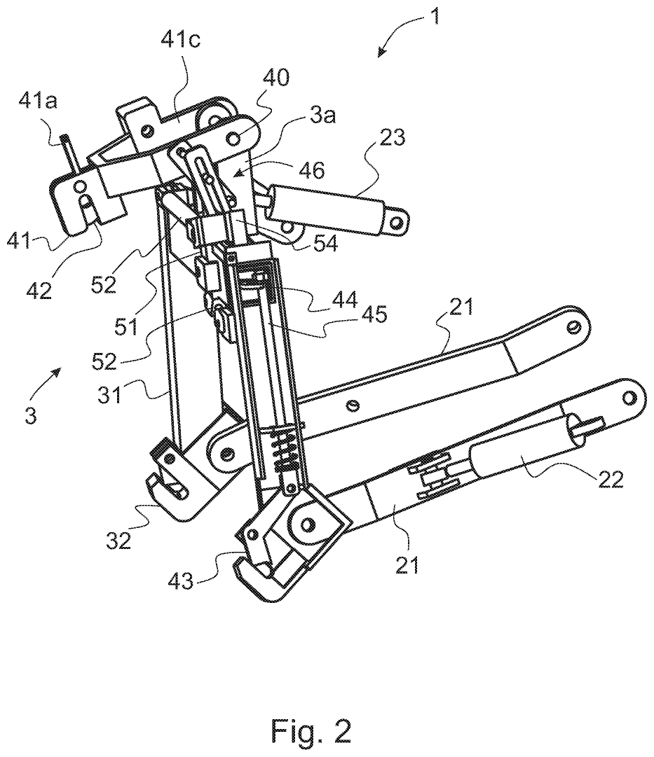

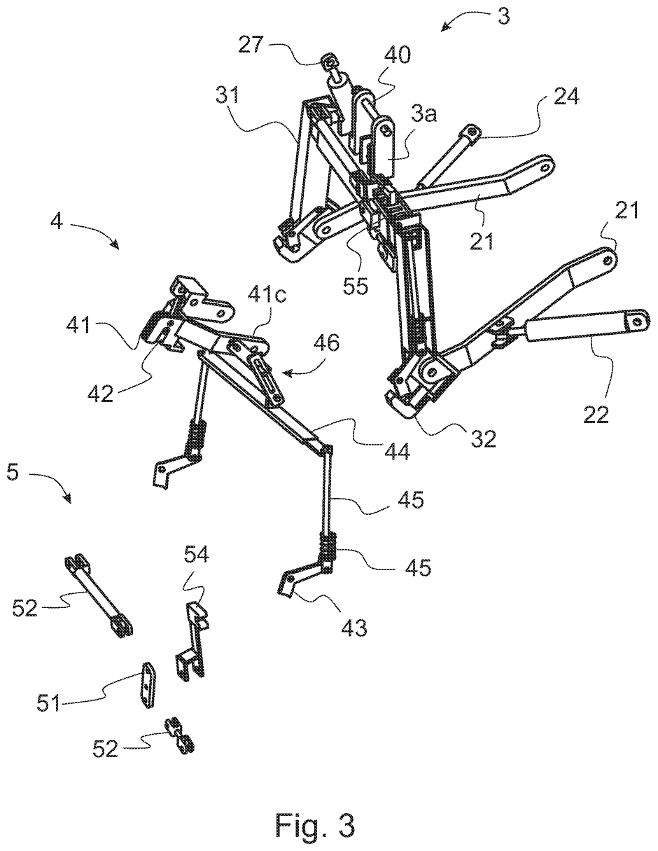

FIGS. 1a to 3 are oblique lateral views, in partial cross-section, of a quick hitch 1 according to a preferable embodiment of the invention. In FIG. 1a the quick hitch 1 is separated while in FIGS. 2 and 3 the quick hitch 1 is attached to the three-point hitch 1a of the working machine, only shown with two pulling arms 21, a hydraulic pushing arm 23 as well as lateral stoppers 22 and 24. The first lateral stopper 22 is a hydraulic cylinder, acting as a driving element, and the second lateral stopper 24 is either a fixed or a length-adjustable lateral stopper. The second, length adjustable lateral stopper 24 can be a hydraulic cylinder identical to the first lateral stopper 22, or mechanically lockable at a certain length. In case both the lateral stoppers 22 and 24 are hydraulic cylinders the pulling arms 21 are easy to be guided laterally to the fasteners of the quick hitch 1a or the working tool.

As mentioned previously, the pulling arms 21 or lower pulling arms may also be called draw links or lift arms, and the hydraulic pushing arm 23 or upper pushing arm may also be called a top link. In addition, the lateral stoppers 22 and 24 may also be called stabilizer arms.

FIG. 3 also shows the essential parts of the quick hitch 1 as separated from each other.

The quick hitch 1 of the preferable embodiment shown in FIGS. 1 to 3 comprises a width-adjustable frame 3, two legs 31, two lower hooks 32, two lower latches 43 and a latch mechanism 4 for moving them, an upper hook 41 with a support arm, an upper latch 42 and a width adjustment mechanism 5 for adjusting the mutual horizontal distance between the lower hooks 32 and for locking them in the adjusted position.

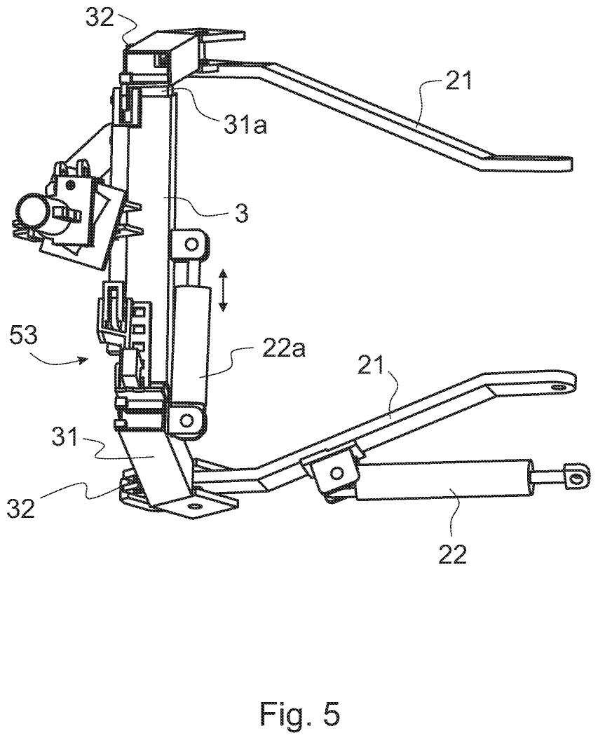

Preferably, the frame 3 is a rectangular tube, for example, having a rectangular but smaller tube 31a, located at the upper end of the legs 31 and similar in cross-section, inserted into its both ends, the rectangular tube 31a of the legs 31 being movable, in a controlled manner, back and forth inside the frame 3 so as to simultaneously move the legs 31 towards or away from each other. The rectangular tubes 31a of the legs 31 can best be seen in FIGS. 5 and 15. The frame 3 also comprises a support structure 3a for connecting the upper hook 41, at its support arms 41c, to the frame 3. In structures where the upper hook 41 travels along a curved path, the support arms 41c are connected to the support structure 3a by a joint 40. To move the upper hook 41, the quick hitch 1 comprises a driving element or actuator 27, such as a hydraulic cylinder connected to the hydraulic system of the working machine and preferably fitted between the frame 3 and the support arms 41c.

The latch mechanism 4 of the quick hitch 1 comprises the upper latch 42 connected to the upper hook 41 and moving jointly with the upper hook 41, with a disengaging mechanism 41a adapted to be operated by using a pulling means 41b, such as a chain, rope or rod, the pulling means 41b extending to the cabin, or to close proximity thereof, in order to allow the operator of the working machine to release the upper latch 42, from the cabin of the working machine. The disengaging mechanism 41a of the upper latch 42 is articulated to the upper hooks 41, the upper latch 42 being adapted to be engaged by a spring force and to be disengaged by means of a lever included in the disengaging mechanism 41a, and of the pulling means 41b, against the spring force.

The latch mechanism 4 also comprises two lower latches 43 for locking the quick hitch 1 to the lower fasteners of the working tool, a length-adjustable latch releaser 44, a disengaging rod 45 provided inside each leg 31 for each lower latch 43, and a release mechanism 46 for the lower latches 43, positioned between the upper hook 41 and the latch releaser 44, to transmit the movement of the upper hook 41 to the lower hooks 43 for the purpose of engaging and disengaging the lower latches 43. The latch mechanism 4 comprises locking springs 45a for locking the lower latches 43 to the lower fasteners of the working tool. The release mechanism 46 of the lower latches 43 is adapted to pull the latch releaser 44 and the disengaging rods 45, which are connected thereto, upwards when the upper hook 41 is turned to its upper position. This disengages the lower latches 43, against the spring force.

The width adjustment mechanism 5 of the lower hooks 32 comprises a first lever mechanism 51, 52 and a locking element 53 for locking the mutual horizontal distance between the lower hooks 32 in the width direction. The width adjustment mechanism 5 is adapted to move the legs, through the first lever mechanism 51, 52, and, at the same time, the lower hooks 32, in a mutually synchronized manner in the width direction of the quick hitch 1, either simultaneously farther away from each other, or simultaneously closer to each other, and at an identical speed with respect to each other, as well as over an equally long distance. The width adjustment mechanism 5 is adapted to be operated from the cabin of the working machine and is preferably connected to the hydraulic system of the working machine but it may as well be connected to the transmission system of the working machine or to the electrical system of the working machine. Alternatively, the quick hitch 1 may comprise a manual actuation means operable from the cabin of the working machine.

The locking element 53 for the width adjustment comprises a locking arm 54 and a locking counterpart 55 provided with locking apertures, the locking head of the locking arm being adapted to be locked, at the locking phase of the width adjustment, into these apertures. The locking counterpart 55 is fastened to the first leg 31 of the quick hitch 1, to be jointly movable with the leg 31. The locking arm 54 is articulated, at its first end, to the first lever mechanism 51, 52, the locking arm 54 thus moving in the width direction of the quick hitch 1 as the mutual distance between the legs 31 is adjusted, and the locking portion of the locking head, provided in the second end of the locking arm 54, being insertable, at the locking phase, into the apertures of the locking counterpart 55 aligned to the locking portion of the locking head. For clarity, the actuator for engaging and disengaging the locking arm 54 is not shown in the Figures.

The locking element 53 is adapted to lock the structure at a desired grip width. The locking portion of the locking element 53 is adapted to be pressed down into the slot-like apertures of the locking counterpart 55 and, thereby, to prevent any unintentional change of the grip width.

The grip width of the quick hitch 1, i.e. the horizontal distance between the lower hooks 32, is adapted to be adjusted by means of the motive power of the hydraulic first lateral stopper 22 and the counteracting second locked lateral stopper 24. The second lateral stopper is a metal rod, for example, fixed at its first end and its second end to the frame of the working machine and to the pulling arm 21, respectively.

The lateral movement of the first lateral stopper 22 at the first leg 31 of the quick hitch 1 is adapted to be transmitted, through the first lever mechanism 51, 52, into a movement changing the distance between the both legs 31, and thereby, also the distance between the lower hooks 32, when the second lateral stopper 24 is connected to the second pulling arm 21 to provide counterforce to the first lateral stopper 22. The first width adjustment element 52, such as the upper spreading arm herein, is connected at its first end to the first leg 31 of the quick hitch 1 and its second end to the first end of the rocker arm 51. The second, the lower width adjustment element 52, such as the lower spreading arm herein, is connected at its first end to the second leg 31 of the quick hitch 1 and its second end to the second end of the rocker arm 51. The rocker arm 51 is articulated, between its ends, to the frame 3 to turn around its joint.

The movement of the first lateral stopper 22 at the second leg 31 of the quick hitch 1 is also adapted to move the entire quick hitch 1 in the lateral direction. This operation is enabled by locking the locking element 53 and by unlocking the second lateral stopper 24, for example by disconnecting the second lateral stopper 24 from the pulling arm 21 with the result that the counterforce of the second lateral stopper 24 does not restrict the lateral movement of the quick hitch 1.

The lower latches 43 of the quick hitch 1 are adapted to be disengaged by the movement of the upper hook 41. The movement of the upper hook 41 is adapted to be transmitted to the lower latch 43 by means of a movement transmitted by the second release mechanism 46, the length-adjustable latch releaser 44 and the disengaging rod 45. The release mechanism 46 of the lower latches 43 connected to the structure of the upper hook 41 is adapted to cause a lifting movement for the latch releaser 44 once the release mechanism 46 has moved to its uppermost extreme position.

In this embodiment, the lower latches 43 allow the quick hitch 1 also to be used as a two-point hitch. Since the lower latches 43 lock the lower hooks 32, a reliable attachment is achieved also when the upper hook 41 is not engaged.

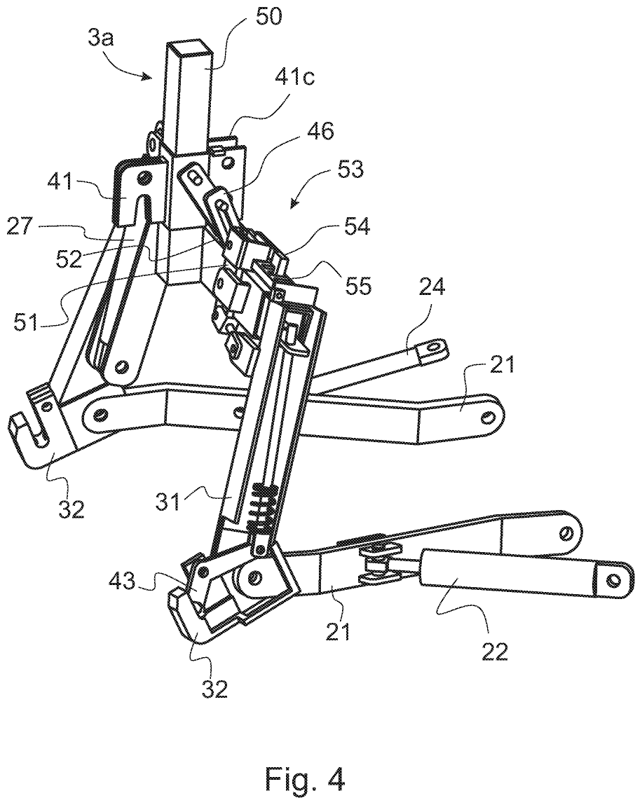

FIG. 4 shows a second quick hitch 1 according to the invention where the upper portion of the latch mechanism 4 differs from the above-described structure for the support structure of the upper hook 41. In this embodiment, the upper hook 41 does not turn around a joint but is provided on the support structure 3a which, now, is a substantially straight supporting and guiding post which guides the linear movement of the upper hook 41 and which is provided with sliding and guiding surfaces 50 and along which the upper hook 41 is adapted to move up and down. The movement of the upper hook 41 is adapted to be transmitted to the lower latches 43 by a release mechanism 46 similar to that shown in FIG. 3. The spreading of the legs 31 is also adapted to be carried out in a similar way to that described above or below.

FIG. 5 shows a third quick hitch 1 according to the invention, also having, for the legs 31, a width adjustment mechanism differing from that described above. In this solution, the width adjustment mechanism 5 comprises a separate actuator or driving element 22a, preferably a hydraulic cylinder connected to the hydraulic system of the working machine, for example, and connected at its first end and its second end to the frame 3 of the quick hitch 1 and to the one leg 31 of the quick hitch, respectively. The driving element 22a is adapted to change the distance between the lower hooks 32 of the quick hitch 1. In order to synchronize the width adjustment for both legs 31, the width adjustment mechanism 5 comprises a first lever mechanism 51, 52 and a locking member 53 which are substantially similar to those described above.

The driving element 22a can also be connected to the legs 31 of the quick hitch 1 at its both ends.

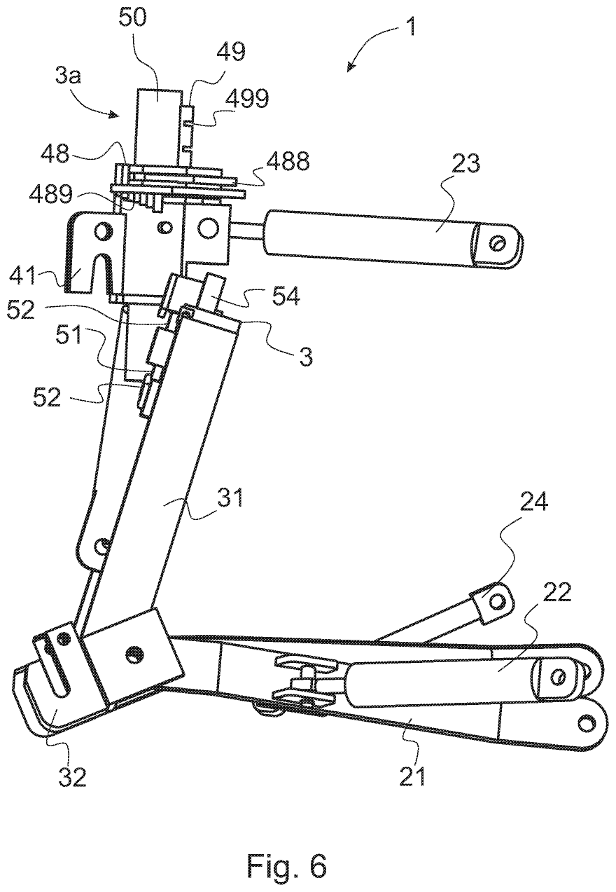

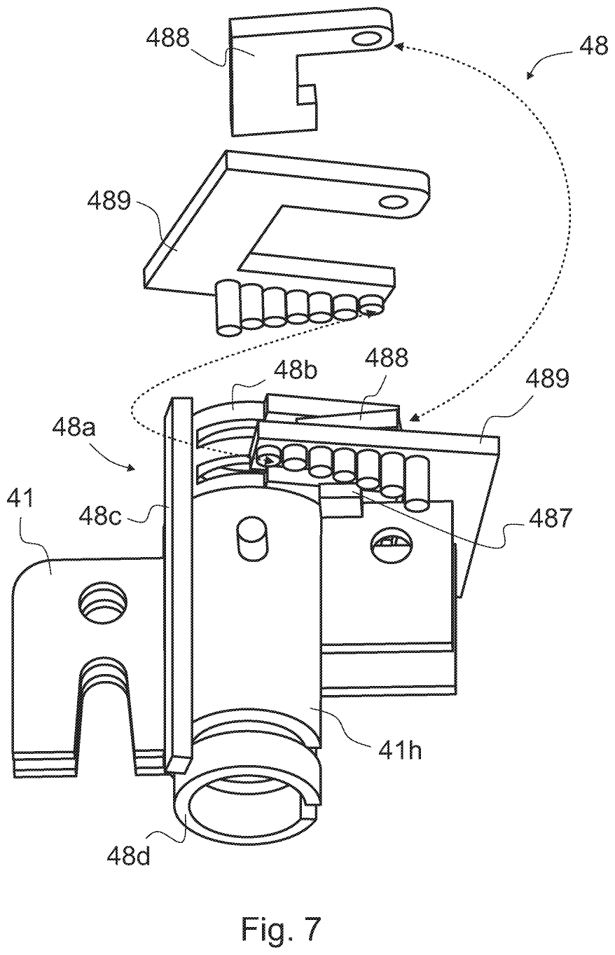

FIGS. 6 and 7 are views of the quick hitch 1 of FIG. 5. FIG. 6 is a simplified and lateral view of the quick hitch 1, with the driving element 22a of FIG. 5 removed. FIG. 7 is an oblique bottom and lateral as well as simplified view of the structure of the upper hook 41 of the quick hitch 1 of FIG. 5 and of a locking device 48 thereof, also showing some parts of the locking device 48 as separated. FIG. 6 also shows parts of the three-point hitch of the working machine, such as the pulling arms 21, the hydraulic pushing arm 23 and the first lateral stopper 22 as well as the length-adjustable second lateral stopper 24. With the exception of the structure of the upper hook 41 and the support structure 3a thereof, the quick hitch 1 can be and operate in a manner substantially similar to that described above.

Thus, the difference from the above is the structure of the upper hook 41, with the support arms and the locking device 48, as well as the support structure 3a of the upper hook 41, comprising a substantially straight locking post, provided with guiding surfaces 50 and having a substantially straight locking rail 49 with locking slots 499 disposed above each other in the height direction.

The locking device 48 is a separate component of the structure acting as a double locking mechanism and is installed in its place around the support structure 3a together with the upper hook 41. The locking device 48 comprises a locking plate 488, a stepped wedge 489, and a frame 48a that has an upper part 48b, a lower part 48d and a connection part 48c whose upper end is fastened to the upper part 48b of the frame 48a and whose lower end is fastened to the lower part 48d of the frame 48a. Further, the upper part 48b comprises two slots, one for the locking plate 488 and the other for the stepped wedge 489. The distance between the lower edge of the upper part 48b and the upper edge of the lower part 48d is greater than the length of the frame part 41h of the upper hook 41. In that case the upper hook 41 with its frame part 41h can be movably installed between the upper part 48b and the lower part 48d of the frame 48a of the locking device 48.

The locking plate 488 and stepped wedge 489 are adapted to restrict, by means of a counterpart 487 fastened to the frame part 41h of the upper hook 41, the movement of the upper hook 41 to be shorter than the distance between the locking slots 499. The stepped wedge 489 and the locking plate 488 are adapted to lock the upper hook 41 in a locking slot 499 of the locking post of the support structure 3a, at a desired distance from the lower hooks 32.

The locking device 48 is adapted to provide, together with the upper hook 41, a clamping force for clamping the fastening pins of the working tool, attached to the quick hitch 1, between the upper hook 41 and the lower hooks 32. The locking device 48 is adapted to be locked in the locking slot 499 of the locking rail 49 of the locking post by means of the locking plate 488. The stepped wedge 489 is adapted to adjust the distance between the upper hook 41 and the lower hook 32, with a sufficient accuracy, to match the fastening elements of the working tool, the quick hitch 1 and the working tool then forming a locked joint. No latch structure 4 is needed in this solution to ensure the attachment of the working tool.

The upper hook 41 can move up and down between the locking slots 499 when the stepped wedge 489 is open. The stepped wedge 489 is used to remove the gap between the fastening pin of the working tool and the upper hook 41. The upper hook 41 can still move the distance equal of two locking slots 499 when the locking plate 488 has already been inserted into one of the locking slots 499 but the stepped wedge 489 is still open, i.e. not yet inserted into its slot.

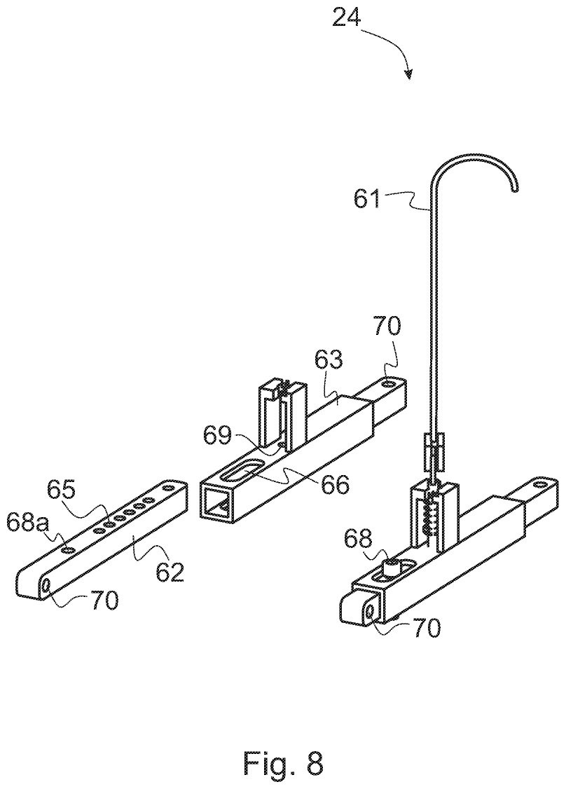

FIG. 8 presents an oblique top and lateral view showing the length-adjustable second lateral stopper 24 of the arrangement according to the invention in a disassembled state and in an assembled state. The length-adjustable lateral stopper 24 comprises a frame 63, which, in this example, is a tubular, partly hollow rod having, in one end, a fastening hole 70, and a release handle 61, which, in this example, is a metal rod. In addition, the frame 63 is provided with a hole 69 for the release handle 61 and with an extended elongated hole 66. The lateral stopper 24 comprises an arm 62 fittable into the hollow portion of the frame 63 and provided with locking holes 65 and the fastening hole 70.

The second lateral stopper 24 is fixed, at its first and its second end, to the pulling arm 21 and to the frame of the working machine, such as the tractor, respectively. The lateral stopper 24 is adapted to be length-adjustable by means of the release handle 61 of the frame 63 and the locking holes 65 of the arm 62. The lower end of the release handle 61 locks, by means of the locking holes 65 of the arm 62, the length of the lateral stopper 24. An upward pulling of the release handle 61 lifts the lower end of the release handle 61 out of the locking hole to release the length locking between the arm 62 and the frame 63. The extended hole 66 is adapted to allow for limited variation of the length of the lateral stopper 24, by means of limiting elements 68 provided in a locking hole 68a. The variation of the length of the lateral stopper 24 is enabled by the movement of the limiting elements 68 in the extended hole 66. Preferably, the inner edges of the extended hole 66 are adapted to act as a limiter of the extremities of the limiting element's 68 travel path.

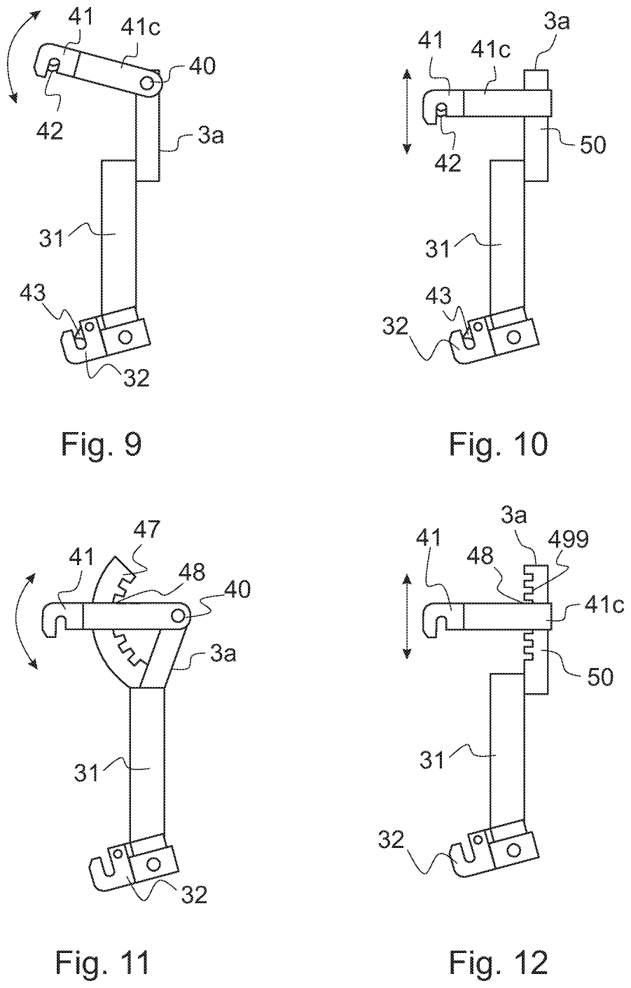

FIGS. 9 to 15 are schematic and simplified views of different preferable embodiments of quick hitches according to the invention.

FIG. 9 shows a preferable quick hitch 1 according to the invention, comprising an upper hook 41 and a fixed support structure 3a for the upper hook 41, the support arms 41c of the upper hook 41 being connected thereto by a joint 40. In addition, the upper hook 41 and the lower hooks 32 comprise an upper latch 42 and lower latches 43, respectively. The upper hook 41 is adapted to travel along a circular arc, around the horizontal joint 40, and the latches of the upper hook 41 and of the lower hooks 32 are adapted to be locked to the fastening elements of the working tool. A similar solution is shown above, i.a. in FIGS. 1a to 3.

FIG. 10 shows another preferable quick hitch 1 according to the invention, having an upper hook 41 and a fixed support structure 3a for the upper hook 41, in this solution, a substantially straight supporting and guiding post which guides the linear movement of the upper hook 41 and is provided with sliding and guiding surfaces 50 and along which the upper hook 41 is adapted to move up and down. In addition, the structure comprises an upper latch 42 for the upper hook 41 and lower hooks 32 with lower latches 43. The upper hook 41 is adapted to move towards the lower hooks 32, and away therefrom, guided by the linear support structure 3a provided with the sliding and guiding surfaces 50, and the latches of the upper hook 41 and of the lower hooks 32 are adapted to be locked to the fastening elements of the working tool. A similar solution is shown above, i.a. in FIG. 4.

FIG. 11 shows still another preferable quick hitch 1 according to the invention, having an upper hook 41 and a fixed support structure 3a for the upper hook 41, the support arms 41c of the upper hook 41 being connected thereto by a joint 40. In addition, the structure incorporates a curved locking plate 47, with locking slots, and a locking device 48. Preferably, the locking device 48 can be similar to the locking device shown in FIG. 7 and comprise, i.a. a locking plate and a stepped wedge supported by bearings on a frame positioned on the horizontal joint 40. The upper hook 41 is adapted to travel along a circular arc, around the horizontal joint 40, and the distance between the upper hook 41 and the lower hooks 32 is adapted to be kept substantially constant by means of the locking device 48 and the curved lock plate 47. The locking device 48 unnecessitates any use of upper or lower latches for securing the attachment of the working tool. The other actuators and structures of the quick hitch 1 can be identical to those described above.

FIG. 12 shows another preferable quick hitch 1 according to the invention, having an upper hook 41 and a fixed support structure 3a for the upper hook 41, herein a substantially straight supporting and guiding post which guides the linear movement of the upper hook 41 and is provided with sliding and guiding surfaces 50, as well as with locking slots 499, and along which the upper hook 41 is adapted to move up and down. In addition, the structure incorporates a locking device 48 and lower hooks 32. The upper hook 41 is adapted to move towards the lower hooks 32, and away therefrom, guided by the linear support structure 3a provided with the sliding and guiding surfaces 50, and the distance between the upper hook 41 and the lower hooks 32 is adapted to be kept substantially constant by means of the locking device 48 and the locking slots 499. The locking device 48 unnecessitates any use of upper or lower latches for securing the attachment of the working tool. The other actuators and structures of the quick hitch 1 can be identical to those described above. A similar solution is shown in FIGS. 5 to 7.

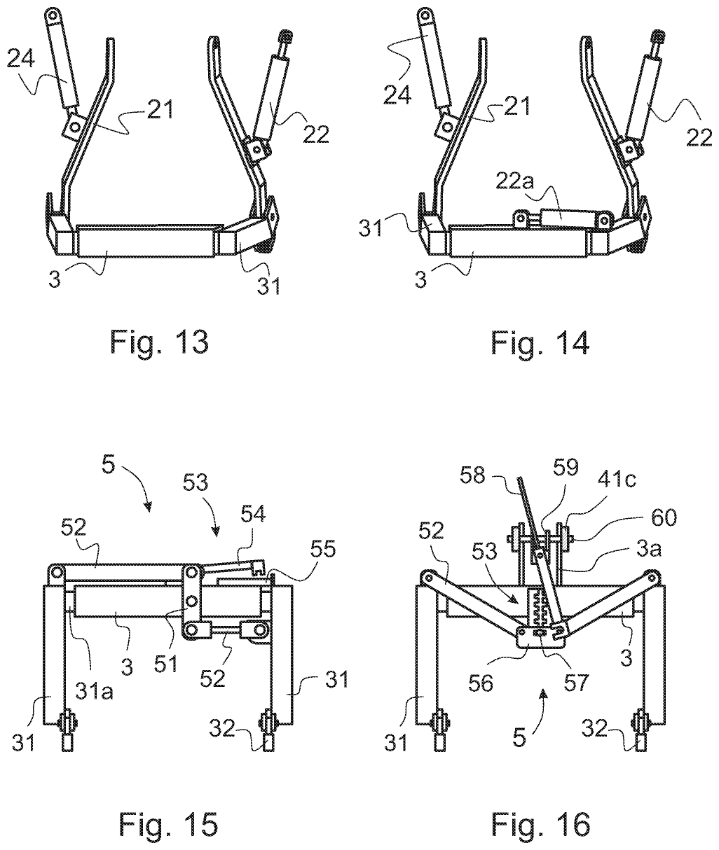

FIGS. 13 to 16 show width adjustment solutions for the legs 31 of the quick hitch 1 according to the invention. In the solution of FIG. 13, a hydraulically driven first lateral stopper 22 is used for the width adjustment, as already described above. Correspondingly, in the solution of FIG. 14 a separate hydraulic actuator 22a, preferably attached onto the frame 3, is used for the width adjustment. This solution has already been explained above in the description of FIG. 5.

FIGS. 15 and 16 show two separate width adjustment mechanisms with their lever solutions. The solution of FIG. 15 has already been explained above and is applicable to any quick hitches 1 according to the invention.

In the solution of FIG. 16, the driving force for the width adjustment of the legs 31 is provided by the actuator 27 moving the upper hook 41, not shown in FIG. 16 but explained in more detail in the description of FIG. 3. This solution incorporates a lever mechanism for the width adjustment mechanism 5, with its width adjustment element 52 comprising two spreading arms, the first end of the first spreading arm being articulated to the upper end of the first leg 31 and the first end of the second spreading arm being articulated to the upper end of the second leg 31, and the second end of the spreading arms being articulated to a preferably plate-shaped, vertically movable position element 56 lateral to the center part of the frame 3 and intended for a locking element 53.

In addition, the locking element 53 comprises a locking plate provided with a vertical groove and locking slots and guiding the position element 56, the locking plate being laterally attached to the center part of the frame 3. Further, the locking element 53 comprises a rod-shaped coupling arm 58 suspended by a suspension element 59 from an articulated shaft 60 and articulated to turn in two planes, i.e. in the width direction of the quick hitch 1 and in a direction perpendicular thereto. Preferably, the articulated shaft 60 is mounted in the support arms 41c of the upper hook 41.

A spring-loaded locking pin 57 extends through the positioning member 56, the end of the pin, which is larger than the cross-sectional are thereof, is spaced from the surface of the position element 56. The locking pin 57 is provided with a spring pressing the locking pin 57 towards the locking slots of the locking plate. The lower end of the coupling arm 58 comprises a laterally open slot adapted to be fitted, by a turning movement of the coupling arm 58, between the end of the locking pin 57 and the position plate 56, when the locking pin 57, for the width adjustment of the legs 31, must be pulled out of the locking slot of the locking plate. Then, the coupling arm 58 is turned, in the width direction of the quick hitch 1, around the joint of the coupling arm 58, provided in the suspension member 59, thereby positioning the slot of the lower end of the coupling arm 58 laterally to the end of the locking pin. Thereafter, the coupling arm 58 is turned around the articulated shaft 60 to allow the slot of the lower end of the coupling arm 58 to be turned to a position between the end of the locking pin 57 and the position plate 56, onto the shaft of the locking pin 57. Now, the locking pin 57 can be pulled out of the locking slot by turning the upper end of the coupling arm 58 around the articulated shaft 60, towards the working machine. Once the locking pin 57 has been pulled out to an extent that the width locking is released, the height position of the position element 56 is changed by a lifting movement of the upper hook 41, by means the driving element 27. The height position of the position plate 56 is changed by the coupling arm 58. After the change of the height position, the coupling arm 58 is turned aside again, in the width direction of the quick hitch 1, and the locking pin 57 is pressed, by spring force, into the locking slot aligned thereto.

The solution of FIG. 16 is also applicable to any quick hitches 1 according to the invention.

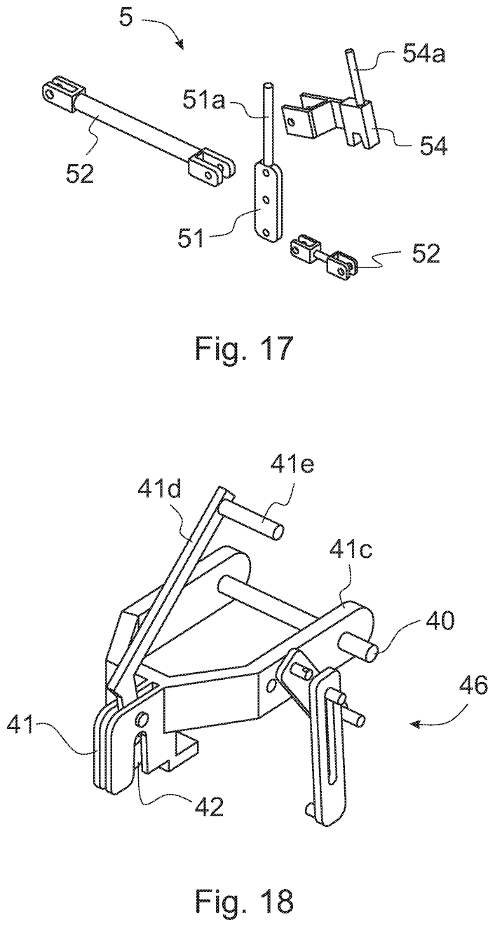

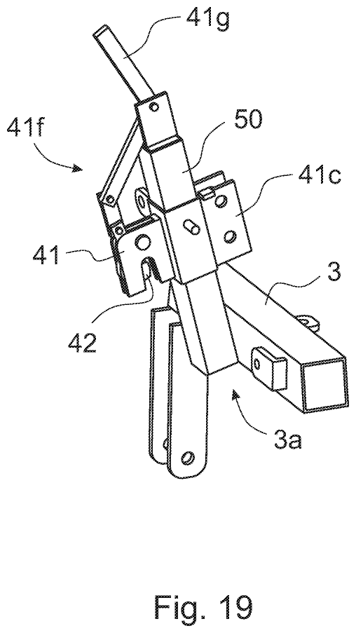

FIGS. 17 to 19 show manual versions of the quick hitch 1 according to the invention, operable from the cabin of the working machine. FIG. 17 shows a manual width adjustment mechanism 5, with its main parts separated, FIG. 18 shows a manually operable structure of the upper hook 41 with its upper latch 42 while FIG. 19 shows a manually operable version corresponding to the quick hitch 1 of FIG. 4.

In FIG. 17 shown width adjustment mechanism 5, which is operable by hand, i.e. manually, comprises a first handle 51a fastened to the first end of the rocker arm 51 of the first lever mechanism, and, a second handle 54a fastened to the locking arm 54 of the width adjustment locking element 53. Both handles 51a and 54a are positioned to be reachable for the operator of the working machine, from the cabin of the working machine. The horizontal distance between the legs 31 of the quick hitch 1 is adjusted by turning the first handle 51a in the width direction of the quick hitch 1, and the width position is locked by turning the locking arm 54 to its locking position, by means the second handle 54a. The overall structure and lever arrangement of the width adjustment mechanism of FIG. 17 is mainly similar to the width adjustment mechanism 5 presented in FIG. 3.

The manually operable upper hook structure shown in FIG. 18 comprises, in addition to the above-mentioned upper hook structure, a third handle 41d having, at its first end, inside the upper hook 41, an upper latch 42, and, at its second end, a grab handle 41e positioned to be easily reachable from the cabin of the working machine. The upper latch 42 is released by turning the third handle 41d around its joint provided in the upper hook, the third handle 41d also being used for lifting the upper hook 41 into a vertical position.

The main difference between the supporting and guiding structure of the upper hook 41 shown in FIG. 19 and the structure shown in FIG. 4 is that the structure now comprises a lever mechanism 41f for manually releasing the upper latch 42 from the cabin of the working machine. The lever mechanism 41f also comprises a handle 41g positioned to be easily reachable from the cabin of the working machine.

The manual versions shown in FIGS. 17 to 19 can also be connected to a driving element or actuator, such as a hydraulic cylinder, allowing them to be actuated by either manual or machine power.

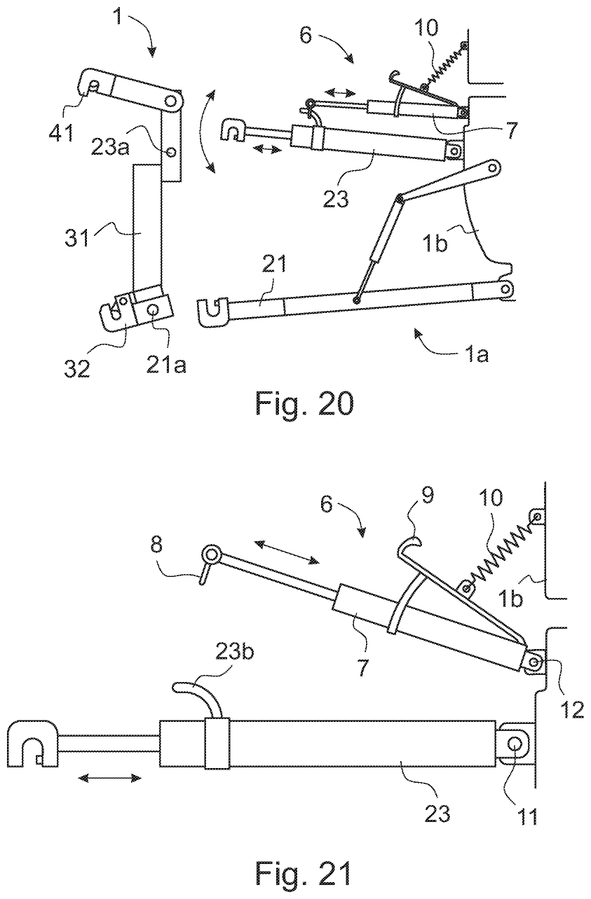

FIGS. 20 and 21 are lateral simplified and clarified views of a preferable lifting and lowering mechanism 6 of the pushing arm 23 of the three-point hitch 1a in the arrangement according to the invention, manually operable from the cabin of the working machine and forming part of the coupling mechanism of the arrangement according to the invention when said lifting and lowering mechanism 6 is installed on the working machine. For clarity, FIGS. 20 and 21 are simplified and they do not show all the structural parts.

A joint 11 connects the pushing arm 23 of the three-point hitch 1a, at the first end thereof, to the rear part 1b of the working machine, for example. Likewise, the pulling arms 21 are articulated, at their first ends, to the rear part 1b of the working machine. In many, especially larger working machines, the pushing arm 23 can be very heavy, making it difficult and dangerous, or even impossible, to move it, by hand, in the vertical plane. Therefore, accurate positioning of the free end, i.e. the second end, of the pushing arm 23 into the fastening element 23a of the working tool, or the quick hitch 1, can be a complicated task. Preferably, the arrangement according to the invention comprises said separate lifting and lowering mechanism 6 for moving the pushing arm 23, substantially in the vertical plane.

The lifting and lowering mechanism 6 comprises a hydraulic cylinder 7 acting as a driving element or actuator and connected, at the first end of the cylinder part, by means of a joint 12, to the rear part 1b of the working machine, above the pushing arm 23 and preferably in the same vertical plane as the longitudinal vertical plane of the pushing arm 23. Preferably, the hydraulic cylinder 7 can be smaller, more lightweight and shorter than the pushing arm 23. The free end of the piston rod of the hydraulic cylinder 7 is provided with a first gripping member 8, preferably an annular member forming a closed loop and extending, from the end of the piston rod, down towards the pushing arm 23.

Correspondingly, the upper surface of the pushing arm 23 is provided with a second gripping member 23b adapted to act as a counterpart of the first gripping member 8. Preferably, the second gripping member 23b has a substantially round cross-section and is adapted to be curved, from the upper surface of the pushing arm towards the hydraulic cylinder 7, and, at the same time, away from the rear part 1b of the working machine. The second gripping member 23b is adapted to fit through the loop of the first gripping member 8 as the lifting and lowering mechanism 6 is connected to the pushing arm 23.

The joint 11 of the pushing arm 23 at the rear part 1b of the working machine is positioned lower and, with respect to the longitudinal direction of the pushing arm 23, further outwards than the joint 12 of the hydraulic cylinder 7 of the lifting and lowering mechanism 6. Thus, the mutual positioning of the joints 11 and 12 is geometrically chosen so that, as the piston rod of the hydraulic cylinder 7, which is connected to the gripping member 23b of the pushing arm, is pulled inwards, the pulling force causes a force component directed substantially upwards and forcing the pushing arm 23 to turn, around its joint 11, towards the above hydraulic cylinder 7, which, in turn, at the same time turns around its joint 12, substantially upwards. Correspondingly, as the piston rod of the hydraulic cylinder 7, which is connected to the gripping member 23b of the pushing arm 23, is pushed outwards, the gravity pulls the pushing arm 23 to turn around its joint 11, substantially downwards. At the same time, the hydraulic cylinder 7 connected to the gripping member 23b turns around its joint 12, substantially downwards.

The lifting and lowering mechanism 6 is also provided with a spring element 10, or a similar element, adapted to lift the hydraulic cylinder 7 upwards, away from top of the pushing arm 23, when the hydraulic cylinder 7 is not connected to the gripping member 23b of the pushing arm. The spring element 10 can be an extension spring, for example, connected between the hydraulic cylinder 7 and the rear part 1b of the working machine.

Preferably, the lifting and lowering mechanism 6 is also provided with a handle 9 allowing the hydraulic cylinder 7 to be laterally moved when connecting the first gripping member 8 with respect to the second gripping member 23b. When the hydraulic cylinder 7 is connected to the pushing arm 23, the handle also allows the pushing arm 23 to be laterally moved. This is helpful especially when the pushing arm 23 is connected to the quick hitch 1, or to a working tool without the quick hitch 1.

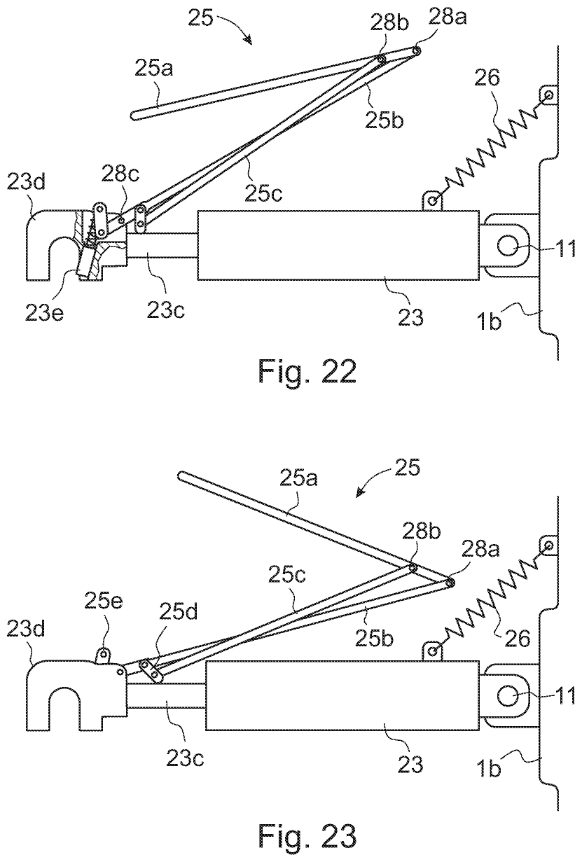

FIGS. 22-24 present in a lateral view an advantageous locking and opening mechanism of the hook 23d of the pushing arm 23 of the three-point hitch 1a according to the invention. The pushing arm 23 is articulated at its second end by a joint 11 for instance to the rear part 1b of the working machine. In addition, the pushing arm 23 is suspended by a spring 26 to lighten the handling of the pushing arm 23.

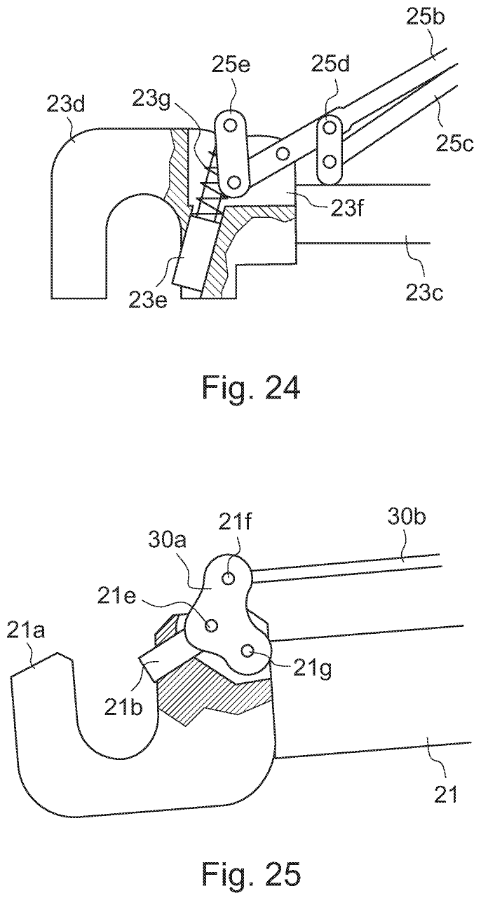

FIG. 22 is a lateral simplified, clarified and partially cross-sectioned view of an advantageous locking and opening mechanism of the pushing arm 23 of the three-point hitch 1a according to the invention in the situation where the pushing arm 23 is in a locked position, whereas FIG. 23 presents the same pushing arm 23 in an unlocked position, and FIG. 24 presents the hook 23d of the same pushing arm 23 in an enlarged and partially cross-sectioned view so that a spring-loaded locking latch 23e placed movably inside the hook 23d is clearly seen. A spring 23g is arranged to press the locking latch 23e to close the throat opening of the hook 23d.

The locking and opening mechanism presented in FIGS. 22-24 comprises a lever mechanism 25 which can be operated from the cabin of the working machine. The lever mechanism 25 comprises a first lever 25a, a second lever 25b, a third lever 25c, a fourth lever 25d and a fifth lever 25e which are articulated to each other with joints. All the levers comprise a first end and a second end. The hook 23d comprises an inner space 23f for the first end of the second lever 25b, fifth lever 25e and spring-loaded locking latch 23e.

The first lever 25a is articulated at its second end by a joint 28a with the second end of the second lever 25b which is further articulated by a joint 28c to the piston of the pushing arm 23, more precisely to the hook 23b at the piston end of the pushing arm 23. The joint 28c is placed from a short distance from the first end of the second lever 25b. Further, the first end of the second lever 25b is articulated by a lower joint at the second end of the fifth lever 25e to the fifth lever 25e. The upper joint at the first end of the fifth lever 25e is articulated to the first end of the locking latch 23e of the pushing arm hook 23d.

In addition, the third lever 25c is articulated at its second end by a joint 28b to the first lever 25a, close to the second end of the first lever 25a, and at its first end to the lower joint at or close to the second end of the fourth lever 25d which fourth lever 25d is further articulated at its first end by an upper joint to the second lever 25b, which upper joint is placed at a distance from the joint 28c towards the second end of the second lever 25b. The second end of the fourth lever 25d rests against the upper surface of the piston rod of the pushing arm 23, and thus locks and keeps the lever mechanism 25 steady in its position when the first lever 25a is not turned.

FIG. 23 presents the pushing arm hook 23d in an unlocked position. In order to unlock the hook 23d the first lever 25a is turned upwards around the joint 28a. In that case the third lever 25c draws the fourth lever 25d at its second end so that the fourth lever 25d turns around its upper joint and at the same time allows the second lever 25b to turn around the joint 28c so that the first end of the second lever 25b moves upwards and at the same time draws the locking latch 23e upwards through the fifth lever 25e. This unlocks the hook 23d and the pushing arm 23 can be turned upwards around the joint 11.

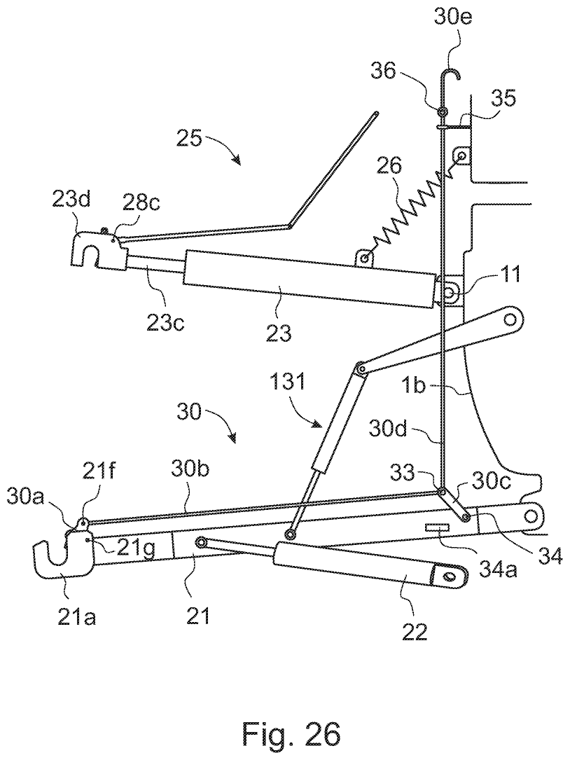

FIGS. 25 and 26 present in a lateral view an advantageous locking and opening mechanism 30 of the hook 21a of each pulling arm 21 of the three-point hitch 1a according to the invention. FIG. 25 is a lateral simplified, clarified, enlarged and partially cross-sectioned view of the free end of the pulling arm 21 in the situation where the locking latch 21b of the hook 21a of the pulling arm 21 is in a locked position, and FIG. 26 presents in a lateral view said locking and opening mechanism 30 of the pulling arm hook 21a, which locking and opening mechanism 30 is manually operable from the cabin of the working machine.

The locking and opening mechanism 30 is a lever mechanism that comprises at least a joint assembly 30a, a first lever member 30b, a second lever member 30c, a third lever member 30d and a grip handle 30e, which lever members are suitably articulated by joints to each other. In addition, locking and opening mechanism 30 comprises a support element 35 to keep the upper end of the third lever member 30d substantially steady in a horizontal direction. The locking and opening mechanism 30 also comprises a substantially transversal connection bar 36 to connect the locking and opening mechanisms 30 of each pulling arm 21 to each other so that both the locking and opening mechanisms 30 can be simultaneously operated by the grip handle 30e.

The joint assembly 30a comprises three joints 21e, 21f and 21g. A locking latch 21e is articulated by the joint 21e to the joint assembly 30a, and the first end of the first lever member 30b is articulated by the joint 21f to the joint assembly 30a. Further, the joint assembly 30a itself is articulated by the joint 21g to the hook 21a of the pulling arm 21. The locations of the joints 21e, 21f and 21g are selected so that when the first lever member 30b is drawn away from the hook 21a the joint assembly 30a turns around the joint 21g and joint 21e draws the locking latch 21b obliquely upwards away from the throat opening of the hook 21a. This unlocks the hook 21a, and the pulling arm 21 can be turned downwards around its joint.

As mentioned previously, the first end of the first lever member 30b is articulated by the joint 21f to the joint assembly 30a. The first lever member 30b is a substantially thin rod that is substantially parallel with the pulling arm 21 and extends from the joint assembly 30a towards the rear part 1b of the working machine. The first lever member 30b is articulated at its second end by a joint 33 to the first end of the second lever member 30c that is further articulated at its second end by a joint 34 to the pulling arm 21. Further, the second end or lower end of the third lever member 30d is articulated by the already mentioned joint 33 to the first end of the second lever member 30c.

The locations of the joints 33 and 34 at the both ends of the second lever member 30c are selected so that the joint 33 is upper and closer to the hook 21a than the joint 34. In that case, in the locking position of the hook 21a, the second lever member 30c is in an inclined position where its first end is upper than its second end and closer to the hook 21a than its second end. That makes the locking and unlocking the hook 21a easy, and it can be done from the cabin of the working machine. When the hook 21a is unlocked the grip handle 30e is drawn upwards in which case the second lever member 30c turns around its joint 34 so that its first end turns away from the hook 21a and at the same time draws the first lever member 30b away from the hook 21a. This unlocks the hook 21a and the pulling arm 21 can be turned downwards around its joint as has been previously mentioned.

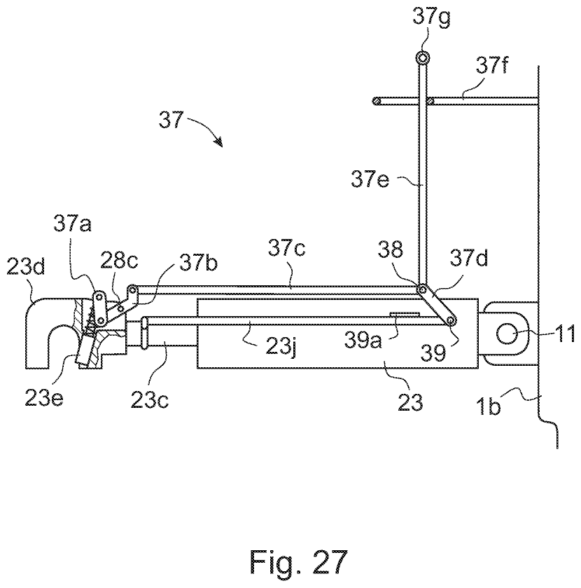

FIG. 27 presents in a lateral simplified, clarified and partially cross-sectioned view another advantageous locking and opening mechanism of the hook 23d of the pushing arm 23 of the three-point hitch 1a in the arrangement according to the invention. Though it is not presented in FIG. 27 the pushing arm 23 may also be suspended by a similar spring 26 as shown in FIG. 26 to lighten the handling of the pushing arm 23. The locking and opening mechanism presented in FIG. 27 comprises a lever mechanism 37 which can be operated from the cabin of the working machine. The lever mechanism 37 comprises a first lever 37a, a second lever 37b, a third lever 37c, a fourth lever 37d and a fifth lever 37e which are articulated by joints to each other. All the levers comprise a first end and a second end. In addition, the locking and opening mechanism comprises a support member 37f close to the upper end of the substantially vertical fifth lever 37e that also has a grip handle 37g at its upper end for operating the locking and opening mechanism from the cabin of the working machine. The hook 23d also comprises an inner space for the first lever 37a, second lever 37b and spring-loaded locking latch 23e.

The first lever 37a with its joints and functions is similar to the fifth lever 25e in FIGS. 22 and 24. The second lever 37b is articulated by a joint 28c to the piston of the pushing arm 23, more precisely to the hook 23b at the piston end of the pushing arm 23. The joint 28c is placed from a short distance from the first end of the second lever 37b. Further, the first end of the second lever 37b is articulated by a lower joint at the second or lower end of the first lever 37a. The second end of the second lever 37b beyond the joint 28c is bent upwards and is articulated by a joint to the first end of the third lever 37c.

The third lever 37c may be a substantially thin rod that is substantially parallel with the pushing arm 23 and extends from the second lever 37b towards the rear part 1b of the working machine. Further, the third lever 37c is articulated at its second end by a joint 38 to the first end of the fourth lever 37d that is further articulated at its second end by a joint 39 to the second end of a measure rod 23j. The first end of the measure rod 23j is fastened to the piston rod 23c so that the measure rod 23j moves with the piston rod 23c. Further, the second end or lower end of the fifth lever 37e is articulated by the already mentioned joint 38 to the first end of the fourth lever 37d.

The locations of the joints 38 and 39 at the both ends of the fourth lever 37d are selected so that the joint 38 is upper than the joint 39 and closer to the hook 23d than the joint 39. In that case, in the locking position of the hook 23d, the fourth lever 37d is in an inclined position where its first end is closer to the hook 23d than its second end. That makes the locking and unlocking the hook 23d easy, and it can be done from the cabin of the working machine. When the hook 23d is unlocked the grip handle 37g is drawn upwards in which case the fourth lever 37d turns around its joint 39 so that its first end turns away from the hook 23d and at the same time draws the third lever 37c away from the hook 23d. In that case the second lever 37b turns around the joint 28c so that the first end of the first lever 37a moves upwards and at the same time draws the locking latch 23e upwards. This unlocks the hook 23d and the pushing arm 23 can be turned upwards around the joint 11.

The structures of the locking and opening mechanisms of the hooks 21a and 23d can also be different from those presented above. Advantageously, a part of the levers and rods or all the levers and rods of the locking and opening mechanism may be replaced by wires or other flexible means and, when needed, properly placed deflection or diverting pulleys. Also wires with jackets, such as accelerator cables or alike may be used instead of the lever mechanisms presented above.

Preferably, the three-point hitch 1a comprises a hydraulic levelling assembly 131 which is useful in many operations of the hitch. Locking latches 21b and 23e may also be self-locking. For that purpose, the solution of the invention comprises locking stoppers 34a and 39a, shown in FIGS. 26 and 27. The automatic locking of the locking latch 21b of the pulling arm 21 is activated by pushing the third lever member 30d downwards as far as the first end of the lever 30c stops against the locking stopper 34a. Correspondingly, the locking of the locking latch 23e of the pushing arm 23 is activated by pushing the fifth lever 37e downwards as far as the first end of the lever 37d stops against the locking stopper 39a. The dimensions of the levers of the locking and opening mechanisms and positions of the joints in the structure have been selected so that the locking latches 21b and 23e keep locked as long as the grip handles 30e and 37g are kept in their lowermost position. When the grip handles 30e and 37g are drawn upwards the locking latches 21b and 23e are drawn in the unlocked position.

The principal idea of the invention is to make it faster, and in general, possible to safely attach various implements and working tools to a three-point hitch of a working machine, such as a tractor. Thus, one of the main ideas is to allow the three-point hitch and its hooks to be easily and safely operated from the cabin of the working machine in order to accurately lower the pushing arm of the three-point hitch, even if it is heavy, by means of the coupling mechanism, to the right position on a fastening element of the a working tool, or of a quick hitch serving as an adapter, and in order to lift it away therefrom. Besides, in a preferred arrangement, the coupling mechanism comprises pulling and transmission means, such as flexible ropes or chains or appropriately designed rods and/or lever mechanisms, allowing the attaching of the three-point hitch to the working tool or to the quick hitch to be managed in a controlled way, for instance by unlocking the quick coupling hooks of the three-point hitch. Preferably, the pushing, pulling and transmission means are adapted to be operated from the cabin of the working machine.

Further, a preferred idea is to facilitate an arrangement allowing the grip width of the quick hitch 1 to be changed from the cabin of the working machine. The width adjustment mechanism 5 according to the invention and the locking element 53, as well as the actuators of the width adjustment mechanism 5, such as the hydraulic cylinders 22 and 22a and/or, the manual actuators, such as the handles 51a, 54a, 41e and 41g, with their lever mechanisms, constitute means for adjusting the mutual horizontal distance between the lower hooks 32, from the cabin of the working machine, and, at the same, form part of the coupling mechanism of the arrangement according to the invention.

The structure and actuators of the coupling mechanism of the arrangement according to the invention, as well as the number thereof, are adapted to vary case by case. For instance, some of the actuators of the coupling mechanism, such as the above-mentioned width adjustment mechanism 5 of the quick hitch 1, with its actuators, are incorporated in the quick hitch 1, thus only forming part of the coupling mechanism when the quick hitch 1 is used. Correspondingly, the above-mentioned lifting and lowering mechanism 6 of the pushing arm 23 only forms part of the coupling mechanism of the arrangement according to the invention when the lifting and lowering mechanism 6 is installed on the working machine.

In the solution according to the invention, in common to all the locking and opening or unlocking mechanisms for locking latches of the hooks of the pushing arm and the pulling arms is the fact that the lever mechanisms and/or wire mechanisms are guided and/or shielded so that they are secure, safe and reliable to use from the cabin of the working machine, and that they do not get entangled with other structures of the working machine, three-point hitch or working tools causing damages to itself or to other components.

It is obvious to a person skilled in the art that different embodiments of the invention are not solely restricted to the above-described examples but may vary within the accompanying claims. Besides, the solutions described in the different examples may vary between the different exemplary solutions.

It is also obvious to the person skilled in the art that the structure of the release mechanism of the lower latches may differ from that described above. Instead of a lever mechanism, the release mechanism may comprise a chain, rope or any other structure resilient in another direction and only transmitting a force in the pulling direction when the upper hook is lifted.

It is also obvious to the person skilled in the art that the arrangement may comprise a separate rack which can hold the quick hitch and from which it can easily be lifted away, by means of the three-point hitch, and to which it also can be lowered back when no longer needed. The rack allows the quick hitch to be held at an appropriate height off the ground, thus making it easier to fasten the pulling arms of the three-point hitch to the pins of the fastening elements of the three-point hitch, for example.

It is also obvious to the person skilled in the art that the structure of the lifting and lowering mechanism of the pushing arm may differ from that described above. As an example, the first gripping member of the hydraulic cylinder of the lifting and lowering mechanism can be a hook-shaped, almost straight pin, and, correspondingly, the second gripping member of the pushing arm can be an annular member allowing the hook-shaped pin of the first gripping member to be inserted through it.

1. An arrangement for attaching a working tool to a working machine, preferably to a three-point hitch of the working machine, comprising a pushing arm articulated, at one end, to the working machine, and two pulling arms articulated, at one end, to the working machine, wherein the arrangement comprises a coupling mechanism for attaching the three-point hitch, from the cabin of the working machine, to the working tool, or, to a quick hitch positioned between the working tool and the working machine.

2. An arrangement for attaching a working tool to a working machine as defined in claim 1, wherein the coupling mechanism comprises one or more of the following: a lifting and lowering mechanism, operable from the cabin of the working machine, for the pushing arm; pulling and transmission means, operable from the cabin of the working machine, for operating the actuators of the coupling mechanism; a width adjustment mechanism for adjusting, from the cabin of the working machine, the mutual horizontal distance between the lower hooks of the quick hitch.

3. An arrangement for attaching a working tool to a working machine as defined in claim 1, wherein the width adjustment mechanism is adapted to move, through a first lever mechanism, the legs of the quick hitch, and, at the same time, the lower hooks, in a mutually synchronized manner in the width direction of the quick hitch, simultaneously either farther away from each other or simultaneously closer to each other and at a mutually equal speed, as well as over an equally long distance.

4. An arrangement for attaching a working tool to a working machine as defined in claim 3, wherein the width adjustment mechanism, for adjusting said mutual horizontal distance, is adapted to be connected to one or more of the following: the hydraulic system of the working machine, the transmission system of the working machine or the electrical system of the working machine, a manual operating means of the quick hitch.

5. An arrangement for attaching a working tool to a working machine as defined in claim 4, wherein the width adjustment mechanism comprises a locking element for locking the mutual distance between the lower hooks in the width direction.

6. An arrangement for attaching a working tool to a working machine as defined in claim 1, wherein the quick hitch comprises a latch mechanism with two lower latches at the lower hooks, adapted to lock the working tool to the lower hooks, and a latch releaser adapted to release the working tool from the lower hooks.

7. An arrangement for attaching a working tool to a working machine as defined in claim 6, wherein, for releasing the lower latches, the quick hitch comprises a release mechanism for the lower latches, connected between the upper hook of the quick hitch and the latch releaser to transmit, through the release mechanism and the latch releaser, the movement of the upper hook to the lower latches.

8. An arrangement for attaching a working tool to a working machine as defined in claim 1, wherein travel path, control and locking of the upper hook is one of the following:
a rotary movement around a horizontal joint, as well as latching of the upper hooks and the lower hooks to the working tool to keep the vertical distance between the upper hook and the lower hooks substantially constant,
a rotary movement around a horizontal joint and locking of the upper hook to a curved locking plate, provided with locking slots and a locking device, to keep the vertical distance between the upper hook and the lower hooks substantially constant,
a linear movement towards and away from the lower hooks, guided by at least one guiding surface, as well as latching of the upper hook and the lower hooks to the working tool to keep the vertical distance between the upper hook and the lower hooks substantially constant,
a linear movement towards and away from the lower hooks, guided by at least one guiding surface, as well as locking of the upper hook to a substantially linear support structure provided with locking slots, to keep the vertical distance between the upper hook and the lower hooks substantially constant.

9. An arrangement for attaching a working tool to a working machine as defined in claim 1, wherein the quick hitch has means for a lifting and lowering movement of the upper hook, the means comprising driving element, such as a hydraulic cylinder for machine-powered operation, and/or handles, operable from the cabin of the working machine, for manual operation.

10. An arrangement for attaching a working tool to a working machine as defined in claim 1, wherein a hydraulically length-adjustable first lateral stopper, and is connected to one pulling arm of the three-point hitch, while a second lateral stopper, having one of the following length adjustments: fixed, manual, hydraulic, is connected to the other pulling arm.

11. An arrangement for attaching a working tool to a working machine as defined in claim 1, wherein the arrangement comprises a guided, from the cabin of the working machine operable locking and opening mechanism for locking and unlocking the locking latches of the hooks of the pushing arm and pulling arms of the three-point hitch.

12. An arrangement for attaching a working tool to a working machine as defined in claim 11, characterized in that wherein locking and opening mechanism is a lever mechanism or a guided wire mechanism or a corresponding guided flexible mechanism having the first end connected to a corresponding locking latch and the second end located in proximity to the cabin of the working machine.

13. An arrangement for attaching a working tool to a working machine as defined in claim 2, wherein the width adjustment mechanism is adapted to move, through a first lever mechanism, the legs of the quick hitch, and, at the same time, the lower hooks, in a mutually synchronized manner in the width direction of the quick hitch, simultaneously either farther away from each other or simultaneously closer to each other and at a mutually equal speed, as well as over an equally long distance.

14. An arrangement for attaching a working tool to a working machine as defined in claim 2, wherein the quick hitch comprises a latch mechanism with two lower latches at the lower hooks, adapted to lock the working tool to the lower hooks, and a latch releaser adapted to release the working tool from the lower hooks.

15. An arrangement for attaching a working tool to a working machine as defined in claim 3, wherein the quick hitch comprises a latch mechanism with two lower latches at the lower hooks, adapted to lock the working tool to the lower hooks, and a latch releaser adapted to release the working tool from the lower hooks.

16. An arrangement for attaching a working tool to a working machine as defined in claim 4, wherein the quick hitch comprises a latch mechanism with two lower latches at the lower hooks, adapted to lock the working tool to the lower hooks, and a latch releaser adapted to release the working tool from the lower hooks.

17. An arrangement for attaching a working tool to a working machine as defined in claim 5, wherein the quick hitch comprises a latch mechanism with two lower latches at the lower hooks, adapted to lock the working tool to the lower hooks, and a latch releaser adapted to release the working tool from the lower hooks.

18. An arrangement for attaching a working tool to a working machine as defined in claim 2, wherein travel path, control and locking of the upper hook is one of the following:
a rotary movement around a horizontal joint, as well as latching of the upper hooks and the lower hooks to the working tool to keep the vertical distance between the upper hook and the lower hooks substantially constant,
a rotary movement around a horizontal joint and locking of the upper hook to a curved locking plate, provided with locking slots and a locking device, to keep the vertical distance between the upper hook and the lower hooks substantially constant,
a linear movement towards and away from the lower hooks, guided by at least one guiding surface, as well as latching of the upper hook and the lower hooks to the working tool to keep the vertical distance between the upper hook and the lower hooks substantially constant,
a linear movement towards and away from the lower hooks, guided by at least one guiding surface, as well as locking of the upper hook to a substantially linear support structure provided with locking slots, to keep the vertical distance between the upper hook and the lower hooks substantially constant.

19. An arrangement for attaching a working tool to a working machine as defined in claim 3, wherein travel path, control and locking of the upper hook is one of the following:
a rotary movement around a horizontal joint, as well as latching of the upper hooks and the lower hooks to the working tool to keep the vertical distance between the upper hook and the lower hooks substantially constant,
a rotary movement around a horizontal joint and locking of the upper hook to a curved locking plate, provided with locking slots and a locking device, to keep the vertical distance between the upper hook and the lower hooks substantially constant,
a linear movement towards and away from the lower hooks, guided by at least one guiding surface, as well as latching of the upper hook and the lower hooks to the working tool to keep the vertical distance between the upper hook and the lower hooks substantially constant,
a linear movement towards and away from the lower hooks, guided by at least one guiding surface, as well as locking of the upper hook to a substantially linear support structure provided with locking slots, to keep the vertical distance between the upper hook and the lower hooks substantially constant.

20. An arrangement for attaching a working tool to a working machine as defined in claim 4, wherein travel path, control and locking of the upper hook is one of the following:
a rotary movement around a horizontal joint, as well as latching of the upper hooks and the lower hooks to the working tool to keep the vertical distance between the upper hook and the lower hooks substantially constant,
a rotary movement around a horizontal joint and locking of the upper hook to a curved locking plate, provided with locking slots and a locking device, to keep the vertical distance between the upper hook and the lower hooks substantially constant,
a linear movement towards and away from the lower hooks, guided by at least one guiding surface, as well as latching of the upper hook and the lower hooks to the working tool to keep the vertical distance between the upper hook and the lower hooks substantially constant,
a linear movement towards and away from the lower hooks, guided by at least one guiding surface, as well as locking of the upper hook to a substantially linear support structure provided with locking slots, to keep the vertical distance between the upper hook and the lower hooks substantially constant.
